(19) United States
(12) Patent Application Publication
(10) Pub. No.: US 2016/0047506 A1
(43) Pub. Date: Feb. 18, 2016

(54) AIR DUCT COUPLING

(71) Applicant: General Plastics, Inc., Shawnee, OK (US)

(72) Inventor: John P. Inda, Shawnee, OK (US)

(21) Appl. No.: 14/825,969

(22) Filed: Aug. 13, 2015

Related U.S. Application Data
(60) Provisional application No. 62/037,705, filed on Aug. 15, 2014.

(51) Int. Cl. F16L 41/02

(52) U.S. Cl. CPC F16L 41/021

(57) ABSTRACT

An air duct coupling that accommodates several different duct sizes is provided. The coupling comprises a coupling body having two or more coupling arms. Each arm is configured for attachment to an air duct. Each coupling arm comprises at least two coupling necks having differing diameters but concentric about the longitudinal axis of the coupling arm.

### CROSS-REFERENCE TO RELATED APPLICATION

This application claims the benefit of U.S. Provisional Application No. 62/203,705 filed Aug. 15, 2014, which is incorporated by reference.

### FIELD

The present disclosure relates generally to air ducts and more particularly to couplings and/or connectors for air ducts.

### BACKGROUND

In the construction of buildings, which are to be provided with central heating and air conditioning, a network of ducts is extended from a central source of heat or cool air into the various rooms for discharging the heated or cooled air into the rooms. These ducts typically extend through attic space, through spaces between floors of the building or within or beneath the slab or pad foundation of the building. Generally, all such duct systems require lengths of ducts to be connected by various air duct couplings, such as T-joints, straight couplings, Y-joints and 4-way joints. Typically, numerous couplings have to be kept on-hand to accommodate different needs and pipe sizes.

### BRIEF DESCRIPTION OF THE DRAWINGS

FIG. 1 is a schematic perspective view of a pipe or duct coupling in accordance with one embodiment of the invention.

FIG. 2 is a schematic frontal view of the pipe coupling illustrated in FIG. 1.

FIG. 3 is a sectional view taken along line 3-3 of FIG. 1.

### DESCRIPTION

In the description that follows, like parts are marked throughout the specification and drawing with the same reference numerals, respectively. The drawing is not necessarily to scale and the proportions of certain parts have been exaggerated to better illustrate details and features of the invention. The terms “inwardly” and “outwardly” are directions toward and away from, respectively, the geometric axis of a referenced object. Where components of relatively well-known design are employed, their structure and operation will not be described in detail.

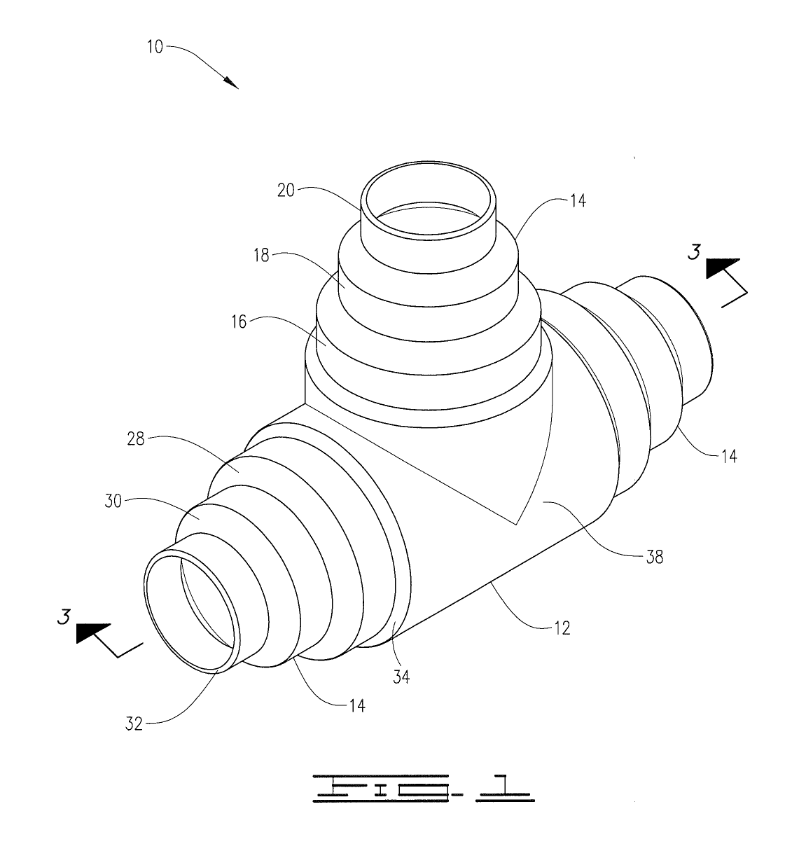

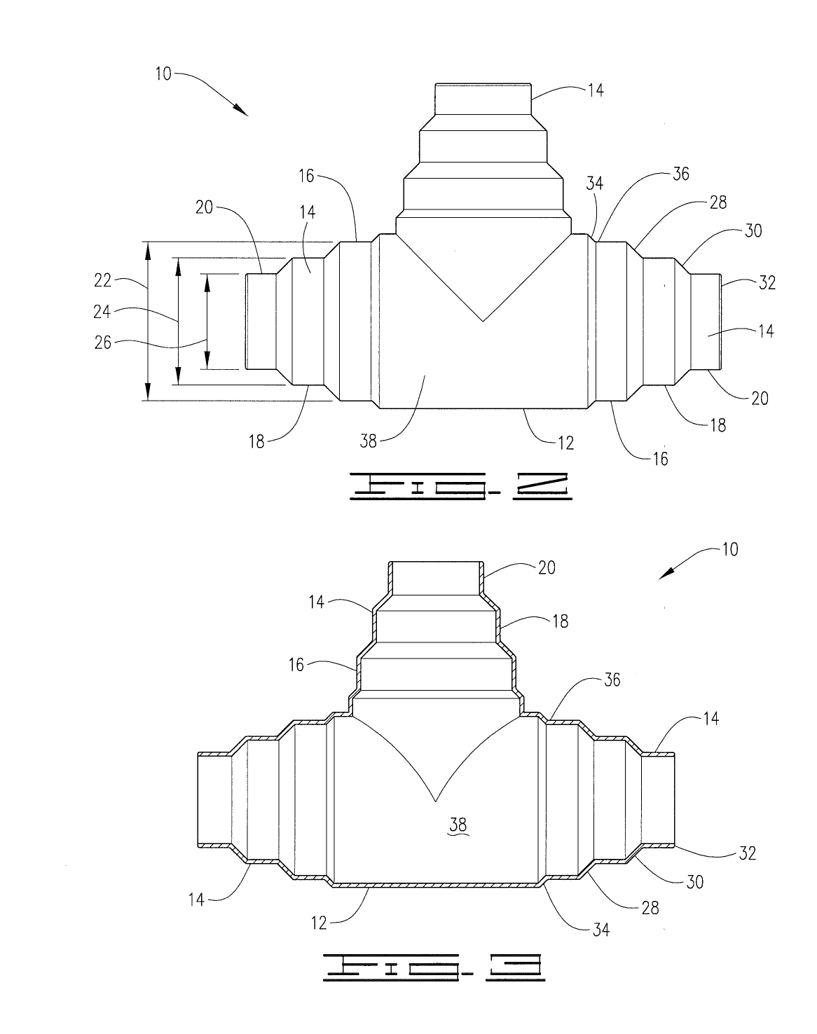

The current invention provides for a pipe or duct coupling 10 that accommodates several different duct sizes; thus, allowing for a reduced inventory of couplings and a reduction in the different couplings brought to a worksite for installation of ducts. The current coupling 10 is illustrated in FIGS. 1-3 and generally comprises a coupling body 12 having two or more coupling arms for attachment to an air duct. Each coupling arm comprises two or more necks 16, 18, 20 having differing diameters but concentric about the longitudinal axis of the coupling arm. Preferably, each coupling arm comprises at least three such concentric necks 16, 18, 20 having differing diameters. More preferably, each neck has only three such concentric necks of differing diameters.

As illustrated, a coupling arm has a first neck 16, second neck 18 and third neck 20. First neck 16 is closest to the coupling body and has a first outer diameter 22 greater than the diameter 24, 26 of the other two necks. Second neck 18 is located between first neck 16 and third neck 20 and has a second outer diameter 24 less than first outer diameter 22 but greater than third outer diameter 26 of the third neck 20. Third neck 20 is located farthest from coupling body 12 and has third outer diameter 26 smaller than first outer diameter 22 and second outer diameter 24. Thus, necks 16, 18, 20 pyramid out from coupling body 12. For example, first outer diameter 22 can be 10 inches; second outer diameter 24 can be 8 inches; and third outer diameter 26 can be 6 inches.

Between first neck 16 and second neck 18 is a first chamfer 28, which provides guidance as a duct is positioned on first neck 16. Between second neck 18 and third neck 20 is a second chamfer 30, which provides guidance as a duct is positioned on second neck 18. Also, third neck 20 ends in a third chamfer 32, which provides guidance as a duct is positioned on third neck 30. Further, a fourth chamfer 34 can be provided at proximal end 36 of first neck 16. Proximal end 36 being located adjacent to the central part 38 of coupling body 12 and away from second neck 18. Alternatively, the fourth chamfer can instead be perpendicular to neck 16 so as to form a shoulder.

The necks and chamfers, are integrally formed with the coupling body. Typically, coupling 10 will be formed or made from a chemically inert synthetic resin. Generally, this will be done by molding the part in one piece; however, the pieces can be molded separately and chemically welded together. Presently, it is preferred that the coupling be formed from polyethylene; however, other resins can be used such as polyvinyl chloride.

Because the coupling arm is comprised of pyramiding necks, each coupling arm can be connected to a variety of different diameter air ducts. For example, the current coupling can be used to connect two or more 10 inch air ducts and also be used to connect two or more 8 inch air ducts or two or more 6 inch air ducts. Thus, instead of having a 10 inch coupling, 8 inch coupling and 6 inch coupling on-hand, the current invention allows for having one coupling on hand to meet the needs of all three air-duct sizes.

Additionally, the coupling can be connected at a first coupling arm to a 10 inch duct and a second coupling arm to an 8 inch duct. Thus, the current invention allows for coupling between different size ducts without maintaining a separate step-down coupling on hand for such connections.

The current coupling can be in any suitable form including: a straight coupling having two coupling arms, an L-shaped coupling having two coupling arms, a T-shaped joint having three coupling arms, a Y-shaped joint having three coupling aims, or a 4-way joint having four coupling arms. Presently, the T-shaped three-arm coupling is preferred. It is preferred that each arm of the coupling can have the pyramiding necks; however, it is within the scope of the invention for only a portion of the coupling arms to have the pyramiding necks. For example, a T-shaped three-arm coupling can have three pyramiding neck arms (as shown in FIGS. 1-3), can have only two pyramiding arms with the third arm comprising only one neck, or can have one pyramiding arm with the other two arms comprising only one neck.

Several specific embodiments will now be described. In one embodiment, an air duct coupling comprises a coupling body having two or more coupling arms. Each coupling arm is configured for attachment to an air duct. Each coupling arm comprises at least two coupling necks having differing diameters but concentric about the longitudinal axis of the coupling arm. In preferred embodiments, the air duct coupling has three and no more than three coupling arms. In some preferred embodiments, the coupling body is a T-shaped joint. In other preferred embodiments, the coupling body is a Y-shaped joint. In some embodiments, the coupling has two arms and the coupling body is an L-Shaped coupling.

Generally, each coupling arm can have a first neck having a first diameter, a second neck having a second diameter, and a third neck having a third diameter with the first diameter, second diameter and third diameter all being different. In some embodiments, each coupling arm has no more than three necks. Typically, the second neck is located between the first neck and third neck with the first neck being located closest to the coupling body and the third neck being located farthest from the coupling body, and wherein the first diameter is greater than the second and third diameter, and the second diameter is greater than the third diameter. In one specific embodiment, the first diameter is about 10 inches, the second diameter is about 8 inches and the third diameter is about 6 inches.

In some embodiments, the coupling body further comprises chamfers between adjacent necks. Thus, where each arm has three necks, there is a first chamfer between the first neck and the second neck and a second chamfer between the second neck and the third neck. Generally, there can also be a chamfer or a shoulder at the proximal end of the first neck. Typically, the coupling arms, necks and chamfers are integrally formed with the coupling body.

In some embodiments, the air duct coupling is formed from a material selected from the group consisting of polyethylene or polyvinyl chloride.

Although the invention has been described with reference to a specific embodiment, the foregoing description is not intended to be construed in a limiting sense. Various modifications as well as alternative applications will be suggested to persons skilled in the art by the foregoing specification and illustrations. It is therefore contemplated that the appended claims will cover any such modifications, applications or embodiments as followed in the true scope of this invention.

What is claimed is:

1. An air duct coupling comprising:
a coupling body having two or more coupling arms configured for attachment to air ducts wherein each coupling arm comprises at least two coupling necks having differing diameters but concentric about the longitudinal axis of the coupling arm.

2. The air duct coupling of claim 1, wherein each coupling arm has a first neck having a first diameter, a second neck having a second diameter, and a third neck having a third diameter with the first diameter, second diameter and third diameter all being different.

3. The air duct coupling of claim 2, wherein the second neck is located between the first neck and third neck with the first neck being located closest to the coupling body and the third neck being located farthest from the coupling body, and wherein the first diameter is greater than the second and third diameter, and the second diameter is greater than the third diameter.

4. The air duct coupling of claim 3, further comprising a first chamfer between the first neck and the second neck and a second chamfer between the second neck and the third neck.

5. The air duct coupling of claim 4, wherein the coupling arms, necks and chamfers are integrally formed with the coupling body.

6. The air duct coupling of claim 5, wherein each coupling arm has no more than three necks.

7. The air duct coupling of claim 6, wherein the first diameter is about 10 inches, the second diameter is about 8 inches and the third diameter is about 6 inches.

8. The air duct coupling of claim 7, wherein the coupling is formed from polyethylene.

9. An air duct coupling comprising:
a coupling body having three coupling arms configured for attachment to air ducts wherein each coupling arm comprises at least two coupling necks having differing diameters but concentric about the longitudinal axis of the coupling arm.

10. The air duct coupling of claim 9, wherein the coupling body has no more than three coupling arms.

11. The air duct coupling of claim 10, wherein the coupling body is a T-shaped joint.

12. The air duct coupling of claim 10, wherein each coupling arm has a first neck having a first diameter, a second neck having a second diameter, and a third neck having a third diameter with the first diameter, second diameter and third diameter all being different.

13. The air duct coupling of claim 12, wherein the second neck is located between the first neck and third neck with the first neck being located closest to the coupling body and the third neck being located farthest from the coupling body, and wherein the first diameter is greater than the second and third diameter, and the second diameter is greater than the third diameter.

14. The air duct coupling of claim 13, further comprising a first chamfer between the first neck and the second neck and a second chamfer between the second neck and the third neck.

15. The air duct coupling of claim 14, wherein the coupling arms, necks and chamfers are integrally formed with the coupling body.

16. The air duct coupling of claim 15, wherein each coupling arm has no more than three necks.

17. The air duct coupling of claim 16, wherein the first diameter is about 10 inches, the second diameter is about 8 inches and the third diameter is about 6 inches.

18. The air duct coupling of claim 17, wherein the coupling body is a T-shaped joint.

19. The air duct coupling of claim 18, wherein the coupling is formed from polyethylene.
